(19) United States
(12) Patent Application Publication
(10) Pub. No.: US 2009/0213736 A1
(43) Pub. Date: Aug. 27, 2009

(54) Method of processing external service request in storage area network

(75) Inventors: Qing-Biao Liu, Tianjin (CN); Xiao-Bin Gao, Tianjin (CN); Tom Chen, Taipei (TW); Win-Harn Liu, Taipel (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/071,817

(22) Filed: Feb. 27, 2008

(51) Int. Cl. H04J 3/24

(52) U.S. Cl. 370/236

(57) ABSTRACT

A method of processing an external service request in a storage area network (SAN) is used for responding a service request in the SAN with multiple controllers, and the method includes the following steps. A first controller of the SAN receives a request packet of an external network. When the first controller determines that the request packet must be transmitted to a second controller actually providing service in an internal network, the request packet is transmitted to the second controller. The second controller receives the request packet, and parses a source address contained therein for recording. The second controller executes an operation instruction corresponding to the request packet, and then generates an acknowledge packet. The second controller takes the source address as a destination address of the acknowledge packet and directly transmits the acknowledge packet to an original request initiator.

### BACKGROUND OF THE INVENTION

1. Field of Invention

The present invention relates to a data processing method for a storage area network. More particularly, the present invention relates to a method of processing an external service request in a storage area network.

2. Related Art

With the development of Internet, storage area network (SAN) is set forth for connecting a plurality of storage devices in the Internet into a virtual large-scale storage equipment. A user accesses data files in the SAN just like accessing a local hard disk device. Compared with a redundant array of independent disks (RAID) of a single server, the file server built through the SAN technology further has the advantages of being capable of infinitely expanding the number of online service hosts and remote backup at a certain degree (service hosts can be disposed dispersedly). Currently, an SAN is mostly built up through iSCSI technology. Generally speaking, one SAN includes one initiator and at least one target, and the so-called target can serve as a server providing a file storage space. When the initiator of the external network transmits a service request packet (referred to as a request packet hereinafter) to the target, the target executes an action corresponding to the request packet to poll the magnetic click providing access service, or store the file data into the corresponding magnetic disk.

The target can also be called as a service controller (referred to as a controller hereinafter). One SAN may include more than one controller. FIG. 1 shows a process of processing an external service request in a conventional SAN. Referring to FIG. 1, the SAN includes a first controller 120 and a second controller 130. When a request initiator of an external network 110 transmits a request packet requesting data access, a first network card 124 on the first controller 120 receives the request packet. A first request processing module 122 determines whether a storage device (for example, a magnetic disk) to be accessed by the request packet exists, if not, a second network card 126 transmits the request packet to another controller, and in this example, to the second controller 130. The second controller 130 receives the request packet through a third network card 134, and executes an operation instruction corresponding to the request packet, so as to access the data file on a magnetic disk 140 through an RAID controller 138. The data file or the acknowledge packet is transmitted to the first controller 120 through the initial transmit path based on the TCP/IP communication protocol, and then transmitted to the request initiator of the external network 110. However, the actual using environment always contains multiple service requests and a large quantity of transmission data, during feeding back the data or the acknowledge packet, a considerable transmission pressure is generated on the request processing module of the controller (for example, the first controller 120) and the external network card, thus affecting the overall transmission speed.

### SUMMARY OF THE INVENTION

In view of the problem that the transmission pressure of the SAN service controller (referred to as controller) affects the overall transmission speed, the present invention is directed to a method for solving the transmission bottleneck problem of the controller by recording a source address of a request initiator and directly feeding back an acknowledge packet and a data packet to the request initiator according to the source address during transmitting the request packet, instead of feeding back through the initial transmission path.

As embodied and broadly described herein, the present invention provides a method of processing an external service request in an SAN. The processing method includes the following steps. A first controller of the SAN receives a request packet of an external network. When the first controller determines that the request packet must be transmitted to a second controller actually providing service in an internal network, the request packet is transmitted to the second controller. The second controller receives the request packet, and parses a source address contained therein for recording. The second controller executes an operation instruction corresponding to the request packet, and then generates an acknowledge packet. The second controller takes the source address as a destination address of the acknowledge packet, and directly transmits the acknowledge packet to an original request initiator.

In the method of processing an external service request in an SAN according to an embodiment of the present invention, the first controller includes a first request processing module for determining whether the request packet is required to be transmitted to the second controller and adding a direct-forward notice in the request packet for being transmitted to the second controller.

In the method of processing an external service request in an SAN according to an embodiment of the present invention, the first controller further includes a first network card for receiving the request packet and transmitting the request packet to the first request processing module; and a second network card for transmitting the request packet to the second controller.

In the method of processing an external service request in an SAN according to an embodiment of the present invention, the second controller includes a second request processing module, for parsing the source address of the request packet, executing an operation instruction corresponding to the request packet, and directly taking the source address as the destination address of the acknowledge packet when it is determined that the request packet contains the forward notice. Further, the source address is recorded in a transmission comparative table built in the second controller, and columns of the transmission comparative table include a source address, a first controller address, a second controller address, and an executive operation instruction.

In the method of processing an external service request in an SAN according to an embodiment of the present invention, the operation instruction of the request packet includes querying logical volume, polling logical volume, reading file data, and writing file data.

In the method of processing an external service request in an SAN according to an embodiment of the present invention, the second controller further includes a third network card for receiving the request packet transmitted from the first controller and transmitting the request packet to the second request processing module; and a fourth network card for transmitting the acknowledge packet to the request initiator.

As described above, in the method of processing an external service request in an SAN of the present invention, the second controller records the source address in the request packet when forwarding the request packet to the second controller. The source address is an address of the request initiator, after the second controller executes the access action, the second controller further rewrites a destination address in the acknowledge packet or the feedback data packet, so as to directly transmit the acknowledge packet or the feedback packet to the request initiator in the external network, thereby avoiding the transmission flux bottleneck caused by feeding back a large quantity of acknowledge packets by the first controller through the original transmission path.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a process of processing an external service request in a conventional storage area network (SAN);

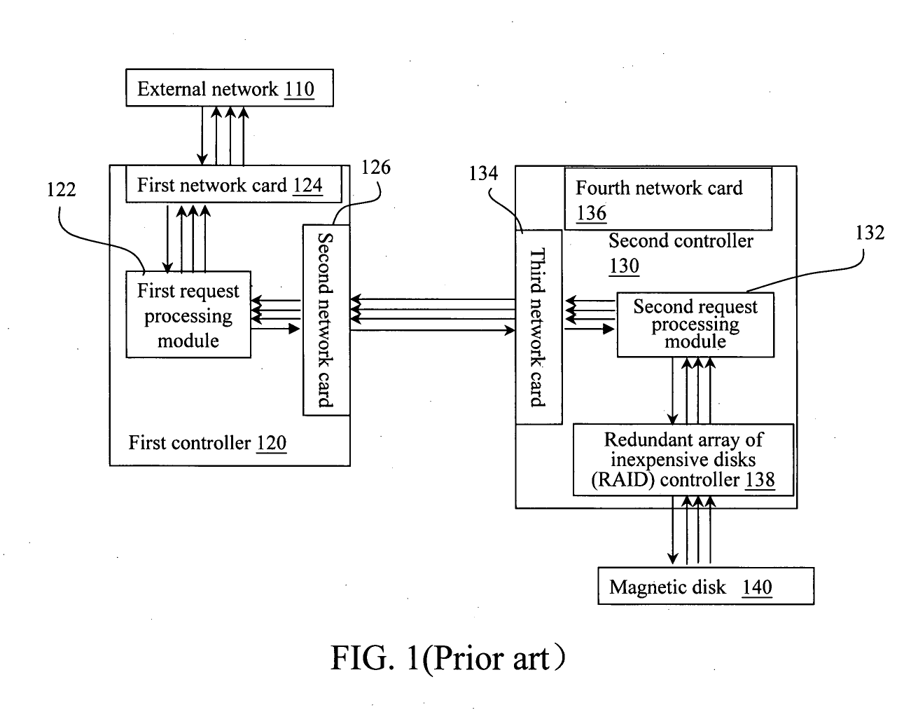

FIG. 2 is a flow chart of a method of processing an external service request in an SAN according to the present invention; and

FIG. 3 is a schematic view of a process of processing an external service request in an SAN according to an embodiment of the present invention.

### DETAILED DESCRIPTION OF THE INVENTION

Objectives of the present invention and implementation thereof are illustrated in detail in the following embodiments. However, the conception of the present invention is also applicable to other scopes, and the following embodiments are described only for illustrating the objectives of the present invention and implementation thereof, instead of limiting the scope thereof.

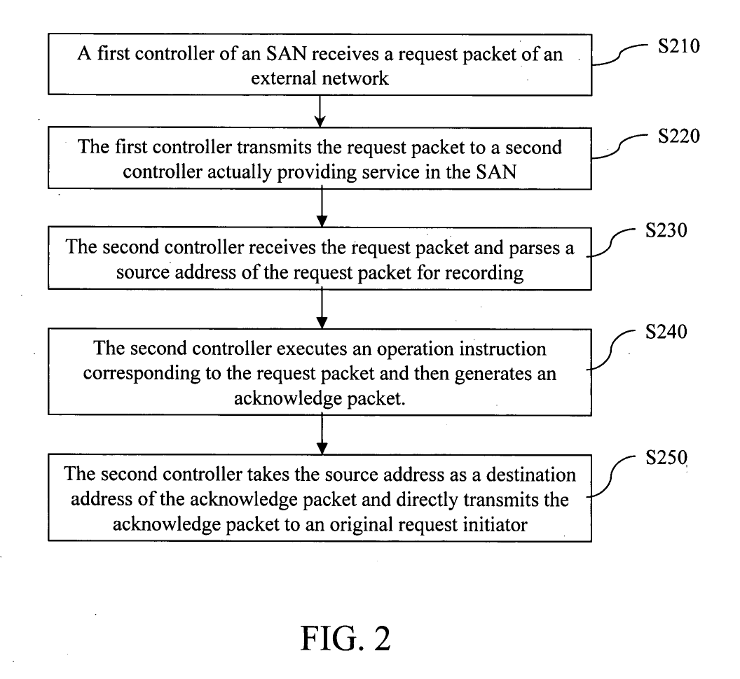

FIG. 2 is a flow chart of a method of processing an external service request in an SAN according to the present invention. Referring to FIG. 2, in this embodiment, the SAN has multiple controllers for controlling the access of magnetic disks, and the method of processing an external service request in the SAN includes the following steps.

First, a first controller of the SAN receives a request packet of an external network (Step S210). Next, the first controller transmits the request packet to a second controller actually providing service in the SAN (Step S220). Then, the second controller receives the request packet and parses a source address of the request packet for recording (Step S230). And then, the second controller executes an operation instruction corresponding to the request packet and then generates an acknowledge packet (Step S240). Finally, the second controller takes the source address as a destination address of the acknowledge packet and directly transmits the acknowledge packet to an original request initiator (Step S250).

A first request processing module in the first controller determines whether a service provided by a local end (first controller end) satisfies the request packet sent by an external network request initiator, if not, the service request is forwarded to an adjacent second controller, and a forward notice is added into the request packet, and then transmitted to the second controller, so as to inform the second controller that if the service request is satisfied, directly transmit the acknowledge packet or the feedback data packet to the request initiator of the external network after executing the service request.

If it is found that the packet contains the forward notice after receiving the request packet, the second controller parses the source address of the request packet and records it in a local memory or storage space. Then, an operation instruction requested by the request packet is parsed, and whether the service provided by the second satisfies the corresponding service of the request packet is checked. The operation instruction includes querying logical volume, polling logical volume, reading file data, and writing file data. If the second controller is capable of actually providing service, the operation instruction corresponding to the request packet is executed, and an acknowledge packet is generated after the execution and fed back to the request initiator. At this time, before feeding back the acknowledge packet (or the data packet), the second controller first modifies the destination address of the packet to be the previously recorded source address, and then transmits the modified acknowledge packet (or the data packet), so as to directly transmit the acknowledge packet (or the data packet) to the external network, thus avoiding the generation of transmission bottleneck of the first controller caused by the transmission of a large quantity of acknowledge packets (or data packets), thereby preventing affecting the overall data transmission speed.

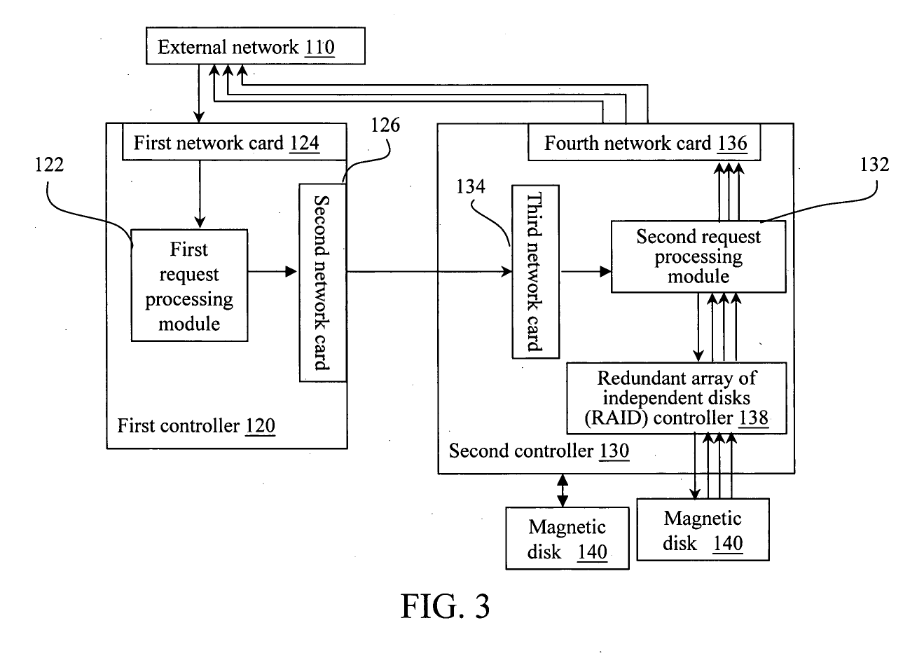

Next, the present invention is further illustrated by FIG. 3 in detail. FIG. 3 is a schematic view of a process of processing an external service request in an SAN according to an embodiment of the present invention. Referring to FIG. 3, a request initiator of an external network 110 transmits a request packet to a first controller 120 to request a data access action on a certain storage equipment. The first controller includes a first request processing module 122, a first network card 124, and a second network card 126. When receiving the request packet, the first network card 124 sends the request packet to the first request processing module 122 and parses the service request object corresponding to the request packet. When it is determined that the first controller 120 does not contain the service request object, it indicates the request packet is required to be transmitted to the second controller 130. At this time, the first request processing module 122 adds a forward notice into the request packet, so as to transmit the request packet to the second controller 130 through the second network card 126. In some embodiments, the packets transmitted to the external network and to the internal network can also be processed merely through one network card, instead of different network cards.

The second controller 130 includes a second request processing module 132, a third network card 134, a fourth network card 136, and a redundant array of independent disks (RAID) controller 138 for controlling a plurality of magnetic disks 140. When receiving the request packet through the third network card 134, the second controller 130 transmits the request packet to the second request processing module 132 for parsing, so as to obtain the source address of the packet and parse the request service item contained in the request packet and the corresponding operation instruction. When the second request processing module 132 finds that the request packet contains the forward notice, the source address is recorded in a built-in transmission comparative table, and items in the request packet, including the address of the controller performing the previous transmission (the first controller), the address of the destination controller (the second controller), and the executive operation instruction, are all recorded into the transmission comparative table. When the second request processing module 132 determines that the service item requested by the request packet can be provided, the second request processing module 132 executes the corresponding operation instruction, and controls the RAID controller 138 to access the magnetic disk 140.

After executing the operation instruction by the second controller 130, the feedback acknowledge packet (or the data packet) is processed by the second request processing module 132 and directly transmitted to the request initiator of the external network 110. Based on TCP/IP communication protocol, the destination address of the acknowledge packet (or the data packet) should be the controller address performing the previous transmission. Particularly, in this embodiment, before transmitting the acknowledge packet (or the data packet) by the second request processing module 132, the source address is obtained from the transmission comparative table to replace the destination address of the original acknowledge packet (or the data packet), and then the acknowledge packets (or data packets) are directly transmitted to the request initiator of the external network 110 through the fourth network card 136, instead of through the first controller 120. In this embodiment, merely two controllers for controlling the processing of the external service request are described, but the present invention is not limited to two controllers. The transmission bottleneck of multiple controllers or of any systematic architecture due to a client-server architecture can be eliminated through the method of the present invention, so as to avoid influence of the transmission bottleneck on the overall transmission speed caused by transmitting a large quantity of acknowledge packets.

What is claimed is:

1. A method of processing an external service request in a storage area network (SAN), applicable to an SAN with multiple controllers, comprising:
receiving a request packet of an external network by a first controller of the SAN;
the first controller transmitting the request packet to a second controller actually providing service in the SAN;
the second controller receiving the request packet, and parsing a source address of the request packet for recording;
the second controller executing an operation instruction corresponding to the request packet, and then generating an acknowledge packet; and
the second controller taking the source address as a destination address of the acknowledge packet and directly transmitting the acknowledge packet to an original request initiator.

2. The method of processing an external service request in an SAN as claimed in claim 1, wherein the first controller comprises a first request processing module, for determining whether the request packet is required to be transmitted to the second controller, adding a forward notice into the request packet, and transmitting the request packet to the second controller.

3. The method of processing an external service request in an SAN as claimed in claim 2, wherein the first controller further comprises:
a first network card, for receiving the request packet, and transmitting the request packet to the first request processing module; and
a second network card, for transmitting the request packet to the second controller.

4. The method of processing an external service request in an SAN as claimed in claim 2, wherein the second controller comprises a second request processing module, for parsing the source address of the request packet, executing the operation instruction corresponding to the request packet, and directly taking the source address as the destination address of the acknowledge packet when it is determined that the request packet contains the forward notice.

5. The method of processing an external service request in an SAN as claimed in claim 4, wherein the operation instruction of the request packet comprises querying logical volume, polling logical volume, reading file data, and writing file data.

6. The method of processing an external service request in an SAN as claimed in claim 1, wherein the source address is recorded in a transmission comparative table built in the second controller, and columns of the transmission comparative table are selected from a group consisting of a source address, a first controller address, a second controller address, and an executive operation instruction.

7. The method of processing an external service request in an SAN as claimed in claim 4, wherein the second controller further comprises:
a third network card, receiving the request packet transmitted by the first controller, and transmitting the request packet to the second request processing module; and
a fourth network card, for transmitting the acknowledge packet to the request initiator.
